(19) United States
(12) Patent Application Publication
(10) Pub. No.: US 2019/0181412 A1
(43) Pub. Date: Jun. 13, 2019

(54) NON-POROUS BATTERY SEPARATOR AND METHODS OF MAKING SAME

(71) Applicant: Massachusetts Institute of Technology, Cambridge, MA (US)

(72) Inventors: Ju Li, Weston, MA (US); Martin Z. Bazant, Wellesley, MA (US); Peng Bai, Cambridge, MA (US); Chang An Wang, Beijing (CN); Kai Liu, Malden, MA (US)

(21) Appl. No.: 16/280,357

(22) Filed: Feb. 20, 2019

Related U.S. Application Data
(63) Continuation of application No. PCT/US2017/051337, filed on Sep. 13, 2017.
(60) Provisional application No. 62/393,864, filed on Sep. 13, 2016.

(51) Int. Cl. H01M 2/16; H01M 10/0525; H01M 10/0566; H01M 2/14; H01M 2/18

(52) U.S. Cl. CPC H01M 2/1653; H01M 10/0525; H01M 2/18; H01M 2/145; H01M 10/0566

(57) ABSTRACT

This invention provides a non-porous battery separator comprising an elastomeric material, wherein the elastomeric material is permeable to metal ions but not appreciably permeable to other chemical species. A battery comprising the non-porous battery separator is also provided. Methods of making a non-porous battery separator are also provided.

### CROSS-REFERENCES TO RELATED APPLICATIONS

This application claims the benefit of priority, under 35 U.S.C. § 120, to PCT Application Serial No. PCT/US2017/051337, entitled, “Non-Porous Battery Separator and Methods of Making,” filed Sep. 13, 2017, which in turn claims the benefit of priority, under 35 U.S.C. § 119(e), to U.S. Provisional Application Ser. No. 62/393,864, entitled “Solid Electrolyte Separator with Large Reversible Elastic Strains Stops Li Dendrites and Enables Stable Cycling of Li Metal Anode at High Current Densities and Areal Capacities,” filed Sep. 13, 2016; the entirety of each of the aforementioned applications is hereby expressly incorporated herein by reference for all purposes.

### GOVERNMENT SUPPORT

This invention was made with Government support under Grant No ECCS-1610806 awarded by the National Science Foundation. The Government has certain rights in the invention.

### BACKGROUND

While the lithium metal anode has the highest theoretical capacity for lithium batteries, it is plagued by a number of undesirable factors, such as the growth of lithium dendrites, side reactions with liquid and solid electrolytes, volume change, and a moving contact interface with the electrolyte during cycling.

The lithium metal anode, which has extremely high capacity and low redox potential, is key for next generation batteries. Bruce et al., Li O₂ and Li S batteries with high-energy storage. Nat Mater 11, 19-29 (2012); Xu et al., Lithium metal anodes for rechargeable batteries, Energ. Environ. Sci. 7, 513 537 (2014), both of which are hereby incorporated by reference. However, the lithium metal anode has drawbacks, such a poor safety reputation, low Coulombic efficiency, and short cycle life, where uneven deposition of lithium, especially dendrite dendritic growth, is believed to be the root cause. Aurbach et al., A short review of failure mechanisms of lithium metal and lithiated graphite anodes in liquid electrolyte solutions. Solid State Ionics 148, 405-416 (2002); Lu et al., Failure Mechanism for Fast-Charged Lithium Metal Batteries with Liquid Electrolytes, Advanced Energy Materials 5 (2015) (“Lu”), both of which are hereby incorporated by reference. Non-uniform electrodeposition produces a large surface area that leads to extensive side reactions with the common liquid electrolytes to form the solid electrolyte interphase (SEI) layer, which irreversibly consumes active lithium and the electrolyte, yielding very low Coulombic efficiency and short cycle life. Lu et al., Electrochemical in situ investigations of SEI and dendrite formation on the lithium metal anode. Phys Chem Chem Phys 17, 8670-8679 (2015); Aurbach, Review of selected electrode solution interactions which determine the performance of Li and Li ion batteries, J Power Sources 89, 206-218 (2000), both of which are hereby incorporated by reference. Meanwhile, during discharge, the root of a dendrite whisker is often dissolved first, making the top part disconnected, causing dead lithium and therefore capacity loss. Yamaki et al., A consideration of the morphology of electrochemically deposited lithium in an organic electrolyte J Power Sources 74, 219-227 (1998); Aryanfa et al., Quantifying the dependence of dead lithium losses on the cycling period in lithium metal batteries, Phys Chem Chem Phys 16, 24965-24970 (2014), both of which are hereby incorporated by reference. Moreover, lithium dendrites may grow through the pores of traditional porous separators to short circuit the cell internally, which may lead to thermal runaway and even explosion.

Solid electrolytes such as solid ceramic polymer or composite materials can function as separator and electrolyte at the same time. Murugan et al., Fast lithium ion conduction in garnet-type Li7L-a3Zr2012, Angew Chem Int Ed 46, 7778-7781 (2007); Kanno & Maruyama, Lithium ionic conductor thin LISICON—The Li2S-GeS2-P2S5 system, J Electrochem Soc 148, A742-A746 (2001); Xie et al., NASICON-type Li1+2xZr2-xCax(PO4)(3) with high ionic conductivity at room temperature, Rsc Adv 1, 1728-1731 (2011); Liu. & Wang, Garnet type Li6.4LeZr1.4Ta0.6012, thin sheet: Fabrication and application in lithium-hydrogen peroxide semi-fuel cell. Electrochem Commun 48, 147-150 (2014); Agrawal & Pandey, Solid polymer electrolytes: materials designing and all-solid state battery applications: an overview, J Phys D Appl Phys 41 (2008); Bouchet et al., Single-ion BAB triblock copolymers as highly efficient electrolytes for lithium metal batteries, Nat Mater 12, 452-457 (2013); Zhang et al., Novel composite polymer electrolyte for lithium air batteries. J Power Sources 195, 1202-1206 (2010); Chen et al., High discharge capacity solid composite polymer electrolyte lithium battery, J Power Sources 196, 2802-2809 (2011); Choi et al., Enhancement of ionic conductivity of composite membranes for all-solid-state lithium rechargeable batteries incorporating tetragonal Li.7La3Zr2012 into a polyethylene oxide matrix, J Power Sources 274, 458-463 (2015), all of which are hereby incorporated by reference. For example, in a fully dense ceramic separator, its non-porous structure, high strength and absence of flammable organic liquid electrolyte can help to stop lithium dendrite penetration and enhance the safety of lithium metal batteries. However, the ionic conductivity of ceramic electrolytes is still not high enough and the large dimensional change of lithium metal during cycling makes it difficult to maintain good contact inside the battery. Scrosati & Garche, Lithium batteries: Status, prospects and future, J Power Sources 195, 2419-2430 (2010), which is hereby incorporated by reference in its entirety. The lithium metal necessarily needs to retract in discharge. Maintaining good contact of a moving interface with a solid electrolyte over a long distance for Li transportation is challenging. One solution, adding an external spring-load, can help accommodate the volume change and maximize contact in cycling, but this is a large footprint solution, which will add weight to the battery, thus lowering the practical energy density.

Accordingly, there is still an unmet need in the art for a battery separator that can maintain consistent interfacial contact over a surface with uneven metal (e.g., lithium) depositions and prevents dendritic (e.g., lithium) penetration.

### SUMMARY

In view of the foregoing challenges relating to the development of a battery separator that can maintain consistent interfacial contact over a surface with uneven metal (e.g., lithium) depositions and prevents dendritic (e.g., lithium) penetration, various inventive embodiments disclosed herein are generally directed to overcoming this challenge. The present disclosure is generally directed to a non-porous battery separator comprising an elastomeric material, wherein the elastomeric material is permeable to metal ions but not appreciably permeable to other chemical species. A battery comprising the non-porous battery separator is also provided. Methods of making a non-porous battery separator are also provided.

In one embodiment, the present disclosure is directed a non-porous battery separator comprising an elastomeric material, wherein the elastomeric material is permeable to metal ions but not appreciably permeable to other chemical species.

In another embodiment, the present disclosure is directed to a battery comprising the non-porous battery separator described herein.

In another embodiment, the present disclosure is directed to a method of making a non-porous battery separator comprising

(a) condensing one or more acid-containing molecules with one or more amine-containing molecules;

(b) reacting the product of step (a) with one or more urea-containing molecules; and

(c) immersing the product of step (b) in an electrolyte solution.

In another embodiment, the present disclosure is directed to a non-porous battery separator made by the process of

(a) condensing one or more acid-containing molecules with one or more amine-containing molecules;

(b) reacting the product of step (a) with one or more urea-containing molecules; and

(c) immersing the product of step (b) in an electrolyte solution;

wherein, said non-porous battery separator has one or more of the following properties:

(1) a thickness from about 1 μm to about 200 μm; and/or

(2) a diameter from about 3 mm to about 50 mm; and/or

(3) a tensile strength from about 50 Pa to about 50 MPa; and/or

(4) an electrical resistance from about 100 Ohms to about 5000 Ohms; and/or

(5) no visible pores in the elastomeric material at a resolution of 1 nm.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates the behaviors of a traditional plastic porous separator (a) and a designed non porous elastomeric solid-electrolyte separator (b) interacting with uneven lithium deposition at high current densities and large areal capacity.

FIG. 2 shows digital photos of SEM images of the surfaces and cross sections of the rubber separators before (a, b, c) and after (d, e, f) swelling in the organic liquid electrolyte for 30 days.

FIG. 3 illustrates the effects of organic liquid electrolyte uptake on the mechanical and electrochemical properties of the rubber separator. (a) Organic liquid electrolyte uptake by the rubber separator; (b) Tensile test results of the rubber separator samples after different soaking times, with a microporous polypropylene (PP) separator as the control. Loading rate—0.5 N/min; (c) AC impedance spectra of the H-cell with rubber separators measured within 1.5 h-10 h after the assembly, where those of porous PP separator and pure electrolyte (no separator) are also given for comparison; (d) Cycling profile of Li—Li symmetrical cells at a current density of 10 mA cm⁻², and areal capacity of 10 mAh cm⁻². The insert in (d) is the structure of the symmetrical cell. Note that a 50-μm thick PTFE washer was sandwiched between anode and the separator to allow for uneven deposition of lithium beneath the separator and accommodate the elastic deformation of the rubber separator.

FIG. 4 shows in situ snapshots of the capillary cells during first cycle and at the end of last cycle. (a) Without any separator; (b) with PP separator; (c) with the rubber separator described herein.

FIG. 5 shows cycling performance of the capillary cells, 1^{st}, 3^{rd}, and 6^{th} discharge-charge curves of the capillary cells (a) without separator, (b) with porous PP separator and (c) with the rubber separator described herein. (d) Represents the Coulombic efficiency of the corresponding capillary cells.

FIG. 6 shows SEM images of the commercial porous PP separator (Celgard 2400). (a) Surface top view: (b) cross section, side view.

FIG. 7 is a photo of an H-type cell.

FIG. 8 shows AC impedance spectra of the H-type cell with (a) dense PVDP separator with no lithium ionic conductivity and the non-porous rubber separator described herein after soaking for (b) 0 h, (c) 0.5 h. and (d) 1 h.

FIG. 9 illustrates CV curves of Li-Stainless Steel coin cells from −0.2 to 6.5 V at a scan rate of 5 mV s⁻¹. The electrochemical stability of the rubber separator against lithium metal was determined through CV test using a 2032 stainless steel coin cell which used stainless steel plates and lithium foil (0.3 mm in thickness) as the working and counter electrode, respectively. The CV curves of coin cells using our rubber separator and PP separator are highly similar, indicating that the rubber separator did not cause extra side reactions in the cell system. Tested at room temperature.

FIG. 10 illustrates the structure of capillary cells with (a) no separator, (b) the porous PP separator and (c) the rubber separator described herein between two electrodes. The insert in each picture is an enlarged view of the electrodes section. For the cells using a separator, two short capillary tubes were joined together head-to-head with the separator clamped in between, and the connection was sealed with clear silicone sealant. For the cell without a separator, only one long capillary tube was used. All the capillary cells were fixed on a piece of glass plate. Electrodes and electrolytes were loaded inside a glovebox filled with argon gas. In each cell, a piece of lithium metal was wrapped around an exposed end of a thin enameled copper wire and acted as counter and reference electrodes. A thick enameled copper wire with a round exposed head was used as working electrode. After injection of liquid electrolyte, the open ends of the capillary tubes were sealed and the cells were taken out of glovebox.

FIG. 11 shows SEM images of the PP separator after use in the capillary cell.

### DETAILED DESCRIPTION

A new strategy to enhance the performance of a lithium metal anode by utilizing a nonporous elastomeric solid as a battery separator has been discovered. As described herein, a non-porous, elastomeric solid-electrolyte separator was synthesized, which has been surprisingly observed to not only block dendritic growth more effectively than traditional polyolefin separators at large current densities, but is also able to accommodate the large volume change of metal (e.g., lithium metal) by elastic deformation and conformal interfacial motion. Further experiments in coin cells at a current density of 10 mA cm² and a capacity of 10 mAh cm² show improved cycling stability with this new rubber separator. Specially designed transparent capillary cells were assembled to observe the dynamics of the lithium/rubber interface in situ.

Unless otherwise indicated, all numbers expressing dimensions, capacities, conductivities, and so forth used in the specification and claims are to be understood as being modified in all instances by the term “about.” Without limiting the application of the doctrine of equivalents to the scope of the claims, each numerical parameter should at least be construed in light of the number of reported significant digits and by applying ordinary rounding techniques.

As used in this specification and the appended claims, the singular forms “a,” “an,” and “the” include plural referents unless the context clearly indicates otherwise.

As used herein, “battery,” “battery structure,” “electrochemical cell,” “galvanic cell,” and the like are used interchangeably to mean one or more unit cells to convert chemical energy into electrical energy.

As used herein, the term “lithium battery” refers to all types of lithium batteries known in the art, including, but not limited to, rechargeable or secondary lithium ion batteries, non-rechargeable or primary lithium batteries, and other types such as lithium-sulfur batteries.

The primary functional components of a typical battery are the anode; cathode; electrolyte, in which ions move between the anode and cathode in the electrolyte; and a separator between cathode and anode to block passage of electrons (prevent short circuit). Current collectors, normally metal, are used to transport electrons at the cathode and anode. The active ions move from the anode to the cathode during discharge and from the cathode to the anode when charging.

Of course, the non-porous layer should not contain large pores, such as an average pore size of greater than 1 micron. That is, pores should not be available for chemical species to pass through the separator layer directly (i.e., by simple pore diffusion or convection). If there are minor structural defects in the separator layer introduced during battery manufacturing or operation, small amounts of other chemical species can be expected to pass through the layer by convection through the defects.

A non-porous layer is also electronically conductive in addition to providing good lithium-ion conductivity, in certain embodiments of the invention.

One advantage to high ion conductivity is that the non-porous layer does not need to be extremely thin. Rather, the non-porous layer can be relatively thick, allowing it to be structurally freestanding. “Free-standing” here means that the non-porous layer does not need to rely on either the anode or cathode for structural support. In various embodiments, the thickness of the non-porous layer is in the range of about 1 μm to about 200 μm. In certain embodiments, the thickness of the non-porous layer is in the range of about 1 μm to about 100 μm.

As used herein, in the context of describing the separators of the present invention, “rubber” and “elastomeric” are taken to be the same.

Following below are more detailed descriptions of various concepts related to, and embodiments of the non-porous battery separator. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

In one embodiment, the present disclosure is directed a non-porous battery separator comprising an elastomeric material, wherein the elastomeric material is permeable to metal ions but not appreciably permeable to other chemical species. Some variations of the invention are premised on the discovery that a substantially non-porous layer is a beneficial component of a battery separator for lithium-based batteries. Generally speaking, with respect to metals ions selected for a particular battery (i.e., not necessarily lithium ions), a “non-porous” layer means that the layer is permeable to the selected metal ions but not appreciably permeable to other chemical species. For present purposes and in the context of lithium-based battery systems, “substantially non-porous” or “non-porous” are intended to mean that the layer is permeable to lithium ions (Li⁺) but not appreciably permeable to other chemical species. A “chemical species” may refer to an atom, molecule, or particle comprising at least one proton.

In certain embodiments of the present disclosure, the elastomeric material is either partially or fully immersed in an electrolyte solution. For example, in one embodiment, the elastomeric material is partially immersed in an electrolyte solution. In another embodiment, the elastomeric material is fully immersed in an electrolyte solution. Various electrolyte solutions may be used in the battery separator of the present disclosure and are readily apparent to a skilled artisan. In certain embodiments, the electrolyte solution is an organic liquid electrolyte solution. In one embodiment, the organic liquid electrolyte solution is 1 M LiPF₆ in EC/MEC (3:7 v/v).

In an embodiment, the separator of the present disclosure has a thickness from about 1 μm to about 200 μm, including all integers and ranges therebetween. For example, the thickness may be from about 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, to about 200 μm. In certain embodiments, the thickness of the separator is from about 1 μm to about 100 μm. In certain embodiments, the thickness of the separator is from about 50 μm to about 150 μm. In one embodiment, the separator has a thickness of about 100 μm.

In an embodiment, the separator of the present disclosure has a diameter from about 3 mm to about 50 mm, including all integers and ranges therebetween. For example, the diameter may be from about 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, to about 50 mm. In certain embodiments, the diameter of the separator is from about 3 mm to about 20 mm. In certain embodiments, the diameter of the separator is from about 10 mm to about 30 mm. In one embodiment, the separator has a diameter of about 19 mm.

In an embodiment, the separator of the present disclosure has a tensile strength from about 50 Pa to about 50 MPa, including all integers and ranges therebetween. For example the tensile strength may be from about 50 Pa, 75 Pa, 100 Pa, 125 Pa, 150 Pa, 175 Pa, 200 Pa, 225 Pa, 250 Pa, 275 Pa, 300 Pa, 325 Pa, 350 Pa, 375 Pa, 400 Pa, 425 Pa, 450 Pa, 475 Pa, 500 Pa, 525 Pa, 550 Pa, 575 Pa, 600 Pa, 625 Pa, 650 Pa, 675 Pa, 700 Pa, 725 Pa, 750 Pa, 775 Pa, 800 Pa, 825 Pa, 850 Pa, 875 Pa, 900 Pa, 925 Pa, 950 Pa, 975 Pa, 1 MPa, 2 MPa, 3 MPa, 4 MPa, 5 MPa, 6 MPa, 7 MPa, 8 MPa, 9 MPa, 10 MPa, 11 MPa, 12 MPa, 13 MPa, 14 MPa, 15 MPa, 16 MPa, 17 MPa, 18 MPa, 19 MPa, 20 MPa, 21 MPa, 22 MPa, 23 MPa, 24 MPa, 25 MPa, 26 MPa, 27 MPa, 28 MPa, 29 MPa, 30 MPa, 31 MPa, 32 MPa, 33 MPa, 34 MPa, 35 MPa, 36 MPa, 37 MPa, 38 MPa, 39 MPa, 40 MPa, 41 MPa, 42 MPa, 43 MPa, 44 MPa, 45 MPa, 46 MPa, 47 MPa, 48 MPa, 49 MPa to about 50 MPa. In certain embodiments, the tensile strength of the separator is from about from about 100 Pa to about 10 MPa. In certain embodiments, the tensile strength of the separator is from about from about 100 Pa to about 1 MPa. In one embodiment, the separator has a tensile strength is about 400 Pa.

The elastomeric separators of the present invention have a relatively low Young's modulus and a relatively high failure strain characteristic in the art of elastomeric polymers.

In an embodiment, the separator of the present disclosure has an electrical resistance from about 100 Ohms to about 5000 Ohms, including all integers and ranges therebetween. For example the electrical resistance may be from about 100 Ohms, 200 Ohms, 300 Ohms, 400 Ohms, 500 Ohms, 600 Ohms, 700 Ohms, 800 Ohms, 900 Ohms, 1000 Ohms, 1100 Ohms, 1200 Ohms, 1300 Ohms, 1400 Ohms, 1500 Ohms, 1600 Ohms, 1700 Ohms, 1800 Ohms, 1900 Ohms, 2000 Ohms, 2100 Ohms, 2200 Ohms, 2300 Ohms, 2400 Ohms, 2500 Ohms, 2600 Ohms, 2700 Ohms, 2800 Ohms, 2900 Ohms, 3000 Ohms, 3100 Ohms, 3200 Ohms, 3300 Ohms, 3400 Ohms, 3500 Ohms, 3600 Ohms, 3700 Ohms, 3800 Ohms, 3900 Ohms, 4000 Ohms, 4100 Ohms, 4200 Ohms, 4300 Ohms, 4400 Ohms, 4500 Ohms, 4600 Ohms, 4700 Ohms, 4800 Ohms, 4900 Ohms, to about 5000 Ohms. In certain embodiments, the electrical resistance is from about from about 1800 Ohms to about 2000 Ohms.

In an embodiment, there are no visible pores in the elastomeric material at a resolution of 1 nm. The non-porous and dense elastomeric separator of the present disclosure is impermeable to metal dendrites. In certain embodiments, the non-porous and dense elastomeric separator of the present disclosure is impermeable to lithium dendrites. A skilled artisan will appreciate that a battery separator that is impermeable to metal dendrites (e.g., lithium dendrites) does not allow the passage of all or substantially all metal dendrites. Thus, in one embodiment, the non-porous and dense elastomeric separator of the present disclosure is fully impermeable to lithium dendrites.

In another embodiment, the present disclosure is directed to a battery comprising the non-porous battery separator described herein. A variety of batteries may be used in the context of the present disclosure. In one embodiment, the battery is a Li-ion battery.

In an embodiment, the Coulombic efficiency of the battery of the present disclosure is greater than about 50% after the 120th charge cycle. For example, the Coulombic efficiency of the battery of the present disclosure is greater than about 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or about 99% after the 120th charge cycle. In one embodiment, the Coulombic efficiency is greater than about 75% after the 70th charge cycle. For example, the Coulombic efficiency of the battery of the present disclosure is greater than about 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or about 99% after the 70th charge cycle. In another embodiment, the Coulombic efficiency is from about 75% to about 80% after the 6^{th} charge cycle.

In an embodiment, there is no observed drop in voltage after 5 cycles in the battery of the present disclosure. For example, there is no observed drop in voltage after 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 cycles. In one embodiment, there is no observed drop in voltage after 10 cycles. In another embodiment, there is no observed drop in voltage after 25 cycles. In yet another embodiment, there is no observed drop in voltage after 50 cycles. In yet another embodiment, there is no observed drop in voltage after 100 cycles.

In one embodiment, the current density of the cells is from about 0.1 mA cm⁻² to about 100 mA cm⁻². For example, the current density is about 0.1 mA cm⁻², 0.2 mA cm⁻², 0.3 mA cm⁻², 0.4 mA cm⁻², 0.5 mA cm⁻², 0.6 mA cm⁻², 0.7 mA cm⁻², 0.8 mA cm⁻², 0.9 mA cm⁻², 1 mA cm⁻², 2 mA cm⁻², 3 mA cm⁻², 4 mA cm⁻², 5 mA cm⁻², 6 mA cm⁻², 7 mA cm⁻², 8 mA cm², 9 mA cm⁻², 10 mA cm⁻², 11 mA cm⁻², 12 mA cm⁻², 13 mA cm⁻², 14 mA cm⁻², 15 mA cm⁻², 16 mA cm⁻², 17 mA cm⁻², 18 mA cm⁻², 19 mA cm⁻², 20 mA cm⁻², 21 mA cm⁻², 22 mA cm⁻², 23 mA cm⁻², 24 mA cm⁻², 25 mA cm⁻², 26 mA cm⁻², 27 mA cm⁻², 28 mA cm⁻², 29 mA cm⁻², 30 mA cm⁻², 31 mA cm⁻², 32 mA cm⁻², 33 mA cm⁻², 34 mA cm⁻², 35 mA cm⁻², 36 mA cm⁻², 37 mA cm⁻², 38 mA cm⁻², 39 mA cm⁻², 40 mA cm⁻², 41 mA cm⁻², 42 mA cm⁻², 43 mA cm⁻², 44 mA cm⁻², 45 mA cm⁻², 46 mA cm⁻², 47 mA cm⁻², 48 mA cm⁻², 49 mA cm⁻², 50 mA cm⁻², 51 mA cm⁻², 52 mA cm⁻², 53 mA cm⁻², 54 mA cm⁻², 55 mA cm⁻², 56 mA cm⁻², 57 mA cm⁻², 58 mA cm⁻², 59 mA cm⁻², 60 mA cm⁻², 61 mA cm⁻², 62 mA cm⁻², 63 mA cm⁻², 64 mA cm⁻², 65 mA cm⁻², 66 mA cm⁻², 67 mA cm⁻², 68 mA cm⁻², 69 mA cm⁻², 70 mA cm⁻², 71 mA cm⁻², 72 mA cm⁻², 73 mA cm⁻², 74 mA cm⁻², 75 mA cm⁻², 76 mA cm⁻², 77 mA cm⁻², 78 mA cm⁻², 79 mA cm⁻², 80 mA cm⁻², 81 mA cm⁻², 82 mA cm⁻², 83 mA cm⁻², 84 mA cm⁻², 85 mA cm⁻², 86 mA cm⁻², 87 mA cm⁻², 88 mA cm⁻², 89 mA cm⁻², 90 mA cm⁻², 91 mA cm⁻², 92 mA cm⁻², 93 mA cm⁻², 94 mA cm⁻², 95 mA cm⁻², 96 mA cm⁻², 97 mA cm⁻², 98 mA cm⁻², 99 mA cm⁻², or about 100 mA cm⁻² In one embodiment, the current density of the cells is from about 0.1 mA cm⁻² to about 10 mA cm⁻². In one embodiment, the current density is 10 mA cm⁻². In one embodiment, the current density is 1 mA cm⁻².

In one embodiment, the areal capacity is from about 0.5 mAh cm⁻² to about 100 mAh cm⁻². For example, the areal capacity is about 0.5 mAh cm⁻², 0.6 mAh cm⁻², 0.7 mAh cm⁻², 0.8 mAh cm⁻², 0.9 mAh cm⁻², 1 mAh cm⁻², 2 mAh cm⁻², 3 mAh cm⁻², 4 mAh cm⁻², 5 mAh cm⁻², 6 mAh cm⁻², 7 mAh cm⁻², 8 mAh cm⁻², 9 mAh cm², 10 mAh cm⁻², 11 mAh cm⁻², 12 mAh cm′, 13 mAh cm⁻², 14 mAh cm⁻², 15 mAh cm′, 16 mAh cm⁻², 17 mAh cm⁻², 18 mAh cm⁻², 19 mAh cm⁻², 20 mAh cm⁻², 21 mAh cm′, 22 mAh cm′, 23 mAh cm⁻², 24 mAh cm⁻², 25 mAh cm⁻², 26 mAh cm⁻², 27 mAh cm⁻², 28 mAh cm⁻², 29 mAh cm⁻², 30 mAh cm⁻², 31 mAh cm⁻², 32 mAh cm⁻², 33 mAh cm⁻², 34 mAh cm⁻², 35 mAh cm′, 36 mAh cm⁻², 37 mAh cm⁻², 38 mAh cm⁻², 39 mAh cm⁻², 40 mAh cm⁻², 41 mAh cm′, 42 mAh cm⁻², 43 mAh cm⁻², 44 mAh cm⁻², 45 mAh cm⁻², 46 mAh cm⁻², 47 mAh cm⁻², 48 mAh cm⁻², 49 mAh cm⁻², 50 mAh cm⁻², 51 mAh cm⁻², 52 mAh cm⁻², 53 mAh cm⁻², 54 mAh cm⁻², 55 mAh cm′, 56 mAh cm⁻², 57 mAh cm⁻², 58 mAh cm⁻², 59 mAh cm⁻², 60 mAh cm⁻², 61 mAh cm′, 62 mAh cm′, 63 mAh cm⁻², 64 mAh cm⁻², 65 mAh cm⁻², 66 mAh cm⁻², 67 mAh cm⁻², 68 mAh cm⁻², 69 mAh cm⁻², 70 mAh cm⁻², 71 mAh cm⁻², 72 mAh cm⁻², 73 mAh cm⁻², 74 mAh cm⁻², 75 mAh cm′, 76 mAh cm⁻², 77 mAh cm⁻², 78 mAh cm⁻², 79 mAh cm⁻², 80 mAh cm⁻², 81 mAh cm′, 82 mAh cm′, 83 mAh cm⁻², 84 mAh cm⁻², 85 mAh cm⁻², 86 mAh cm⁻², 87 mAh cm⁻², 88 mAh cm⁻², 89 mAh cm⁻², 90 mAh cm⁻², 91 mAh cm⁻², 92 mAh cm⁻², 93 mAh cm⁻², 94 mAh cm⁻², 95 mAh cm⁻², 96 mAh cm⁻², 97 mAh cm⁻², 98 mAh cm⁻², 99 mAh cm⁻², or about 100 mAh cm⁻² In one embodiment, the areal capacity is from about 0.5 mAh cm⁻² to about 20 mAh cm⁻². In one embodiment, the areal capacity is 10 mAh cm⁻².

In one embodiment, the current density of the cells is 10 mA cm⁻² and the areal capacity is 10 mAh cm⁻².

In an embodiment, the battery of the present disclosure further comprises a PTFE washer between the anode and the separator.

In another embodiment, the present disclosure is directed to a method of making a non-porous battery separator comprising

(a) condensing one or more acid-containing molecules with one or more amine-containing molecules;

(b) reacting the product of step (a) with one or more urea-containing molecules; and

(c) immersing the product of step (b) in an electrolyte solution.

In certain embodiments, the methods described herein further comprise the step of pressing the product of step (b) into a membrane prior to step (c). The pressing step is performed at an elevated temperature ranging from about 80° C. to about 180° C. For example, the pressing step is performed at a temperature of about 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., 151° C., 152° C., 153° C., 154° C., 145° C., 156° C., 157° C., 158° C., 159° C., 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., to about 180° C. In one embodiment, the pressing is performed at about 120° C.

Various electrolyte solutions may be used in the method of the present disclosure and are readily apparent to a skilled artisan. In certain embodiments, the electrolyte solution is an organic liquid electrolyte solution. In one embodiment, the organic liquid electrolyte solution is 1 M LiPF₆ in EC/MEC (3:7 v/v).

In an embodiment, the one or more acid-containing molecules and/or the one or more amine-containing molecules and/or the one or more urea-containing molecules may be the same or different in the method of the present disclosure. In one embodiment, the one or more acid-containing molecules are the same. In another embodiment, the one or more acid-containing molecules are different. In one embodiment, the one or more amine-containing molecules are the same. In another embodiment, the one or more amine-containing molecules are different. In one embodiment, the one or more urea-containing molecules are the same. In another embodiment, the one or more urea-containing molecules are different.

A variety of acid-containing molecules may be used in the method of the present disclosure and will be readily apparent to a skilled artisan. In the context of the present disclosure, acid-containing molecules refer to molecules having at least one carboxylic acid or carboxylate moiety. The one or more acid-containing molecules may be monoacids, diacids, triacids, and polyacids (i.e., four or more acid-containing moieties).

The monoacids may be present in the acid-containing mixture from about 0% to about 100%, including all integers and ranges therebetween. For example, the monoacids, which may be the same or different, may be present from about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or about 100% of the acid-containing mixture.

The diacids may be present in the acid-containing mixture from about 0% to about 100%, including all integers and ranges therebetween. For example, the diacids, which may be the same or different, may be present from about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or about 100% of the acid-containing mixture.

The triacids may be present in the acid-containing mixture from about 0% to about 100%, including all integers and ranges therebetween. For example, the triacids, which may be the same or different, may be present from about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or about 100% of the acid-containing mixture.

The polyacids may be present in the acid-containing mixture from about 0% to about 100%, including all integers and ranges therebetween. For example, the polyacids, which may be the same or different, may be present from about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or about 100% of the acid-containing mixture.

In certain embodiments, the one or more acid-containing molecules are present in a mixture of monoacids, diacids, triacids, and polyacids. In certain embodiments, the one or more acid-containing molecules are present in a mixture of about 1% to about 10% monoacids, about 50% to about 90% diacids, and about 1% to about 50% triacids and polyacids. In one embodiment, the one or more acid-containing molecules are present in a mixture of about 4% monoacids, about 79% diacids, and about 17% triacids and polyacids.

A variety of amine-containing molecules may be used in the method of the present disclosure and will be readily apparent to a skilled artisan. In the context of the present disclosure, amine-containing molecules refer to molecules having at least one amine moiety. In one embodiment, the one or more amine-containing molecules are diethylenetriamine molecules.

A variety of urea-containing molecules may be used in the method of the present disclosure and will be readily apparent to a skilled artisan. In the context of the present disclosure, urea-containing molecules refer to molecules having at least one urea moiety. In one embodiment, the one or more urea-containing molecules are urea molecules.

In an embodiment, the products of steps (a) and/or (b) and/or (c) are isolated in the method of the present disclosure. A variety of isolation and extraction techniques may be used in the present disclosure and will be readily apparent to a skilled artisan. In one embodiment, the product of step (a) is isolated. In an embodiment, the product of step (a) is isolated by extracting unreacted amine from the reaction mixture. In one embodiment, the product of step (b) is isolated. In an embodiment, the product of step (b) is isolated by performing an extraction from the crude reaction mixture. In one embodiment, the product of step (c) is isolated. For example, the method of the present disclosure further comprises the step of isolating the immersed product of step (c) after the membrane has undergone sufficient swelling such that the weight gain in the rubber separator is from about 1 wt % to about 300 wt %. For example, the weight gain of the immersed product may be from about 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, 100 wt %, 105 wt %, 110 wt %, 115 wt %, 120 wt %, 125 wt %, 130 wt %, 135 wt %, 140 wt %, 145 wt %, 150 wt %, 155 wt %, 160 wt %, 165 wt %, 170 wt %, 175 wt %, 180 wt %, 185 wt %, 190 wt %, 195 wt %, 200 wt %, 205 wt %, 210 wt %, 215 wt %, 220 wt %, 225 wt %, 230 wt %, 235 wt %, 240 wt %, 245 wt %, 250 wt %, 255 wt %, 260 wt %, 265 wt %, 270 wt %, 275 wt %, 280 wt %, 285 wt %, 290 wt %, 295 wt %, to about 300 wt %. In one embodiment, the weight gain in the rubber separator is about 25 wt %.

In one embodiment, step (b) is performed at an elevated temperature in the method of the present disclosure. In one embodiment, the elevated temperature of step (b) is from about 100° C. to about 200° C. For example, step (b) is carried out at a temperature of about 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., 151° C., 152° C., 153° C., 154° C., 145° C., 156° C., 157° C., 158° C., 159° C., 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., 180° C., 181° C., 182° C., 183° C., 184° C., 185° C., 186° C., 187° C., 188° C., 189° C., 190° C., 191° C., 192° C., 193° C., 194° C., 195° C., 196° C., 197° C., 198° C., 199° C., to about 200° C., In one embodiment, the elevated temperature of step (b) varies from about 135° C. to about 160° C.

In another embodiment, the present disclosure is directed to a non-porous battery separator made by the process of

(a) condensing one or more acid-containing molecules with one or more amine-containing molecules;

(b) reacting the product of step (a) with one or more urea-containing molecules; and

(c) immersing the product of step (b) in an electrolyte solution;

wherein, said non-porous battery separator has one or more of the following properties:

(1) a thickness from about 1 μm to about 200 μm; and/or

(2) a diameter from about 3 mm to about 50 mm; and/or

(3) a tensile strength from about 50 Pa to about 50 MPa; and/or

(4) an electrical resistance from about 100 Ohms to about 5000 Ohms; and/or

(5) no visible pores in the elastomeric material at a resolution of 1 nm.

In another embodiment, the present disclosure is directed to a non-porous battery separator made by the process of

(a) condensing one or more acid-containing molecules with one or more amine-containing molecules;

(b) reacting the product of step (a) with one or more urea-containing molecules; and

(c) immersing the product of step (b) in an electrolyte solution;

wherein, said non-porous battery separator has two or more of the following properties:

(1) a thickness from about 1 μm to about 200 μm; and/or

(2) a diameter from about 3 mm to about 50 mm; and/or

(3) a tensile strength from about 50 Pa to about 50 MPa; and/or

(4) an electrical resistance from about 100 Ohms to about 5000 Ohms; and/or

(5) no visible pores in the elastomeric material at a resolution of 1 nm.

In another embodiment, the present disclosure is directed to a non-porous battery separator made by the process of

(a) condensing one or more acid-containing molecules with one or more amine-containing molecules;

(b) reacting the product of step (a) with one or more urea-containing molecules; and

(c) immersing the product of step (b) in an electrolyte solution;

wherein, said non-porous battery separator has three or more of the following properties:

(1) a thickness from about 1 μm to about 200 μm; and/or

(2) a diameter from about 3 mm to about 50 mm; and/or

(3) a tensile strength from about 50 Pa to about 50 MPa; and/or

(4) an electrical resistance from about 100 Ohms to about 5000 Ohms; and/or

(5) no visible pores in the elastomeric material at a resolution of 1 nm.

In another embodiment, the present disclosure is directed to a non-porous battery separator made by the process of

(a) condensing one or more acid-containing molecules with one or more amine-containing molecules;

(b) reacting the product of step (a) with one or more urea-containing molecules; and

(c) immersing the product of step (b) in an electrolyte solution;

wherein, said non-porous battery separator has four or more of the following properties:

(1) a thickness from about 1 μm to about 200 μm; and/or

(2) a diameter from about 3 mm to about 50 mm; and/or

(3) a tensile strength from about 50 Pa to about 50 MPa; and/or

(4) an electrical resistance from about 100 Ohms to about 5000 Ohms; and/or

(5) no visible pores in the elastomeric material at a resolution of 1 nm.

In another embodiment, the present disclosure is directed to a non-porous battery separator made by the process of

(a) condensing one or more acid-containing molecules with one or more amine-containing molecules;

(b) reacting the product of step (a) with one or more urea-containing molecules; and

(c) immersing the product of step (b) in an electrolyte solution;

wherein, said non-porous battery separator has all of the following properties:

(1) a thickness from about 1 μm to about 200 μm; and/or

(2) a diameter from about 3 mm to about 50 mm; and/or

(3) a tensile strength from about 50 Pa to about 50 MPa; and/or

(4) an electrical resistance from about 100 Ohms to about 5000 Ohms; and/or

(5) no visible pores in the elastomeric material at a resolution of 1 nm.

In certain embodiments, the non-porous battery separator made by the process described herein further comprise the step of pressing the product of step (b) into a membrane prior to step (c). The pressing step is performed at an elevated temperature ranging from about 80° C. to about 180° C. For example, the pressing step is performed at a temperature of about 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., 151° C., 152° C., 153° C., 154° C., 145° C., 156° C., 157° C., 158° C., 159° C., 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., to about 180° C. In one embodiment, the pressing is performed at about 120° C.

Various electrolyte solutions may be used in the non-porous battery separator made by the process of the present disclosure and are readily apparent to a skilled artisan. In certain embodiments, the electrolyte solution is an organic liquid electrolyte solution. In one embodiment, the organic liquid electrolyte solution is 1 M LiPF₆ in EC/MEC (3:7 v/v).

In an embodiment, the one or more acid-containing molecules and/or the one or more amine-containing molecules and/or the one or more urea-containing molecules may be the same or different in the non-porous battery separator made by the process of the present disclosure. In one embodiment, the one or more acid-containing molecules are the same. In another embodiment, the one or more acid-containing molecules are different. In one embodiment, the one or more amine-containing molecules are the same. In another embodiment, the one or more amine-containing molecules are different. In one embodiment, the one or more urea-containing molecules are the same. In another embodiment, the one or more urea-containing molecules are different.

A variety of acid-containing molecules may be used in the non-porous battery separator made by the process of the present disclosure and will be readily apparent to a skilled artisan. In the context of the present disclosure, acid-containing molecules refer to molecules having at least one carboxylic acid or carboxylate moiety. The one or more acid-containing molecules may be monoacids, diacids, triacids, and polyacids (i.e., four or more acid-containing moieties).

The monoacids may be present in the acid-containing mixture from about 0% to about 100%, including all integers and ranges therebetween. For example, the monoacids, which may be the same or different, may be present from about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or about 100% of the acid-containing mixture.

The diacids may be present in the acid-containing mixture from about 0% to about 100%, including all integers and ranges therebetween. For example, the diacids, which may be the same or different, may be present from about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or about 100% of the acid-containing mixture.

The triacids may be present in the acid-containing mixture from about 0% to about 100%, including all integers and ranges therebetween. For example, the triacids, which may be the same or different, may be present from about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or about 100% of the acid-containing mixture.

The polyacids may be present in the acid-containing mixture from about 0% to about 100%, including all integers and ranges therebetween. For example, the polyacids, which may be the same or different, may be present from about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or about 100% of the acid-containing mixture.

In certain embodiments, the one or more acid-containing molecules are present in a mixture of monoacids, diacids, triacids, and polyacids. In certain embodiments, the one or more acid-containing molecules are present in a mixture of about 1% to about 10% monoacids, about 50% to about 90% diacids, and about 1% to about 50% triacids and polyacids. In one embodiment, the one or more acid-containing molecules are present in a mixture of about 4% monoacids, about 79% diacids, and about 17% triacids and polyacids. Suitable acid containing molecules include dimers, trimers, and oligomeric polyacids derived from unsaturated fatty acids such as oleic acid. Dimers etc. of other unsaturated fatty acids can also be used (e.g., palmitoleic acid, vaccenic acid, etc.) The acid containing molecules can further be admixed with other suitable comonomers to provide suitable elastomeric properties.

A variety of amine-containing molecules may be used in the non-porous battery separator made by the process of the present disclosure and will be readily apparent to a skilled artisan. In the context of the present disclosure, amine-containing molecules refer to molecules having at least one amine moiety. In one embodiment, the one or more amine-containing molecules are diethylenetriamine molecules.

A variety of urea-containing molecules may be used in the non-porous battery separator made by the process of the present disclosure and will be readily apparent to a skilled artisan. In the context of the present disclosure, urea-containing molecules refer to molecules having at least one urea moiety. In one embodiment, the one or more urea-containing molecules are urea molecules.

In an embodiment, the products of steps (a) and/or (b) and/or (c) are isolated in the non-porous battery separator made by the process of the present disclosure. A variety of isolation and extraction techniques may be used in the present disclosure and will be readily apparent to a skilled artisan. In one embodiment, the product of step (a) is isolated. In an embodiment, the product of step (a) is isolated by extracting unreacted amine from the reaction mixture. In one embodiment, the product of step (b) is isolated. In an embodiment, the product of step (b) is isolated by performing an extraction from the crude reaction mixture. In one embodiment, the product of step (c) is isolated. For example, the method of the present disclosure further comprises the step of isolating the immersed product of step (c) after the membrane has undergone sufficient swelling such that the weight gain in the rubber separator is from about 1 wt % to about 300 wt %. For example, the weight gain of the immersed product may be from about 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, 100 wt %, 105 wt %, 110 wt %, 115 wt %, 120 wt %, 125 wt %, 130 wt %, 135 wt %, 140 wt %, 145 wt %, 150 wt %, 155 wt %, 160 wt %, 165 wt %, 170 wt %, 175 wt %, 180 wt %, 185 wt %, 190 wt %, 195 wt %, 200 wt %, 205 wt %, 210 wt %, 215 wt %, 220 wt %, 225 wt %, 230 wt %, 235 wt %, 240 wt %, 245 wt %, 250 wt %, 255 wt %, 260 wt %, 265 wt %, 270 wt %, 275 wt %, 280 wt %, 285 wt %, 290 wt %, 295 wt %, to about 300 wt %. In one embodiment, the weight gain in the rubber separator is about 25 wt %.

In one embodiment, step (b) is performed at an elevated temperature in the non-porous battery separator made by the process of the present disclosure. In one embodiment, the elevated temperature of step (b) is from about 100° C. to about 200° C. For example, step (b) is carried out at a temperature of about 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., 151° C., 152° C., 153° C., 154° C., 145° C., 156° C., 157° C., 158° C., 159° C., 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., 180° C., 181° C., 182° C., 183° C., 184° C., 185° C., 186° C., 187° C., 188° C., 189° C., 190° C., 191° C., 192° C., 193° C., 194° C., 195° C., 196° C., 197° C., 198° C., 199° C., to about 200° C. In one embodiment, the elevated temperature of step (b) varies from about 135° C. to about 160° C.

In an embodiment, the non-porous battery separator made by the process of the present disclosure has a thickness from about 1 μm to about 200 μm, including all integers and ranges therebetween. For example, the thickness may be from about 1 μm, 2 μm, 3 μm, 4 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, to about 200 μm. In certain embodiments, the thickness of the non-porous battery separator made by the process of the present disclosure is from about 1 μm to about 100 μm. In certain embodiments, the thickness of the non-porous battery separator made by the process of the present disclosure is from about 50 μm to about 150 μm. In one embodiment, the non-porous battery separator made by the process of the present disclosure has a thickness of about 100 μm.

In an embodiment, the non-porous battery separator made by the process of the present disclosure has a diameter from about 3 mm to about 50 mm, including all integers and ranges therebetween. For example, the diameter may be from about 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, to about 50 mm. In certain embodiments, the diameter of the non-porous battery separator made by the process of the present disclosure is from about 3 mm to about 20 mm. In certain embodiments, the diameter of the non-porous battery separator made by the process of the present disclosure is from about 10 mm to about 30 mm. In one embodiment, the separator has a diameter of about 19 mm.

In an embodiment, the non-porous battery separator made by the process of the present disclosure has a tensile strength from about 50 Pa to about 50 MPa, including all integers and ranges therebetween. For example the tensile strength may be from about 50 Pa, 75 Pa, 100 Pa, 125 Pa, 150 Pa, 175 Pa, 200 Pa, 225 Pa, 250 Pa, 275 Pa, 300 Pa, 325 Pa, 350 Pa, 375 Pa, 400 Pa, 425 Pa, 450 Pa, 475 Pa, 500 Pa, 525 Pa, 550 Pa, 575 Pa, 600 Pa, 625 Pa, 650 Pa, 675 Pa, 700 Pa, 725 Pa, 750 Pa, 775 Pa, 800 Pa, 825 Pa, 850 Pa, 875 Pa, 900 Pa, 925 Pa, 950 Pa, 975 Pa, 1 MPa, 2 MPa, 3 MPa, 4 MPa, 5 MPa, 6 MPa, 7 MPa, 8 MPa, 9 MPa, 10 MPa, 11 MPa, 12 MPa, 13 MPa, 14 MPa, 15 MPa, 16 MPa, 17 MPa, 18 MPa, 19 MPa, 20 MPa, 21 MPa, 22 MPa, 23 MPa, 24 MPa, 25 MPa, 26 MPa, 27 MPa, 28 MPa, 29 MPa, 30 MPa, 31 MPa, 32 MPa, 33 MPa, 34 MPa, 35 MPa, 36 MPa, 37 MPa, 38 MPa, 39 MPa, 40 MPa, 41 MPa, 42 MPa, 43 MPa, 44 MPa, 45 MPa, 46 MPa, 47 MPa, 48 MPa, 49 MPa to about 50 MPa. In certain embodiments, the tensile strength of the non-porous battery separator made by the process of the present disclosure is from about from about 100 Pa to about 10 MPa. In certain embodiments, the tensile strength of the non-porous battery separator made by the process of the present disclosure is from about from about 100 Pa to about 1 MPa. In one embodiment, the non-porous battery separator made by the process of the present disclosure has a tensile strength is about 400 Pa.

In an embodiment, the non-porous battery separator made by the process of the present disclosure has an electrical resistance from about 100 Ohms to about 5000 Ohms, including all integers and ranges therebetween. For example the electrical resistance may be from about 100 Ohms, 200 Ohms, 300 Ohms, 400 Ohms, 500 Ohms, 600 Ohms, 700 Ohms, 800 Ohms, 900 Ohms, 1000 Ohms, 1100 Ohms, 1200 Ohms, 1300 Ohms, 1400 Ohms, 1500 Ohms, 1600 Ohms, 1700 Ohms, 1800 Ohms, 1900 Ohms, 2000 Ohms, 2100 Ohms, 2200 Ohms, 2300 Ohms, 2400 Ohms, 2500 Ohms, 2600 Ohms, 2700 Ohms, 2800 Ohms, 2900 Ohms, 3000 Ohms, 3100 Ohms, 3200 Ohms, 3300 Ohms, 3400 Ohms, 3500 Ohms, 3600 Ohms, 3700 Ohms, 3800 Ohms, 3900 Ohms, 4000 Ohms, 4100 Ohms, 4200 Ohms, 4300 Ohms, 4400 Ohms, 4500 Ohms, 4600 Ohms, 4700 Ohms, 4800 Ohms, 4900 Ohms, to about 5000 Ohms. In certain embodiments, the electrical resistance of the non-porous battery separator made by the process of the present disclosure is from about from about 1800 Ohms to about 2000 Ohms.

In an embodiment, there are no visible pores in the non-porous battery separator made by the process of the present disclosure at a resolution of 1 nm. The non-porous and dense elastomeric separator of the present disclosure is impermeable to metal dendrites. In certain embodiments, the non-porous and dense elastomeric separator of the present disclosure is impermeable to lithium dendrites. A skilled artisan will appreciate that a battery separator that is impermeable to metal dendrites (e.g., lithium dendrites) does not allow the passage of all or substantially all metal dendrites. Thus, in one embodiment, the non-porous and dense elastomeric separator of the present disclosure is fully impermeable to lithium dendrites.

The following non-limiting examples illustrate various aspects of the present invention.

### Examples

### Example 1: Materials and Methods

Synthesis of the rubber separator. The elastomeric separator described herein was synthesized by modifying the procedure reported by Leibler et al. Cordier et al., Self-healing and thermoreversible rubber from supramolecular assembly, Nature 451, 977-980 (2008), which is hereby incorporated by reference in its entirety. The synthesis differed from the procedure reported by Leibler et al., in the last step, where, instead of being swollen with dodecane, the hot pressed rubber separators (about 16 mm in diameter and about 90 μm in thickness) were swollen by immersion in organic liquid electrolyte (e.g., 1 M LiPF₆ in EC/MEC (3:7 v/v) purchased from Ube Industries, Japan.). In one instance, 175 g of Empol 1016 fatty dimer acid mixture (derived from oleic acid) of 4% monoacid, 79% diacid, 17% triacid and polyacids, supplied by Cognis) was condensed with 70.3 g of diethylenetriamine (Alfa, 99%) at 160° C. under nitrogen protection over 24 h. After eliminating unreacted amine by a chloroform/water extraction, oligo-amidoamine resultant was obtained, followed by mixing with 17 g urea (Alfa, 99.3+%). The mixture was heated under nitrogen atmosphere at 135° C. for 1.5 h, and then the temperature was raised up to 160° C. by 5° C. increments every 60 min. After the reaction, ammonia and unreacted urea were extracted by vacuum stripping and water washings. The obtained material was dried under vacuum and hot pressed at 120° C. into membranes with a thickness of about 90 μm. Finally, the membrane was immersed in 1 M LiPF₆ in EC/MEC (3:7 v/v) electrolyte to swell.

Characterization of the Rubber Separator.

For AC impedance measurements in the H-type cell with: (a) no membrane in between, (b) PP membrane in between, and (c) rubber membrane in between, the two gaskets made of silicone rubber were clamped very tightly to ensure that there was no leakage and no liquid electrolyte crossover. The AC impedance was measured using a Gamry Reference 3000 work station with a frequency range of I-1 MHz and amplitude of 5 mV at room temperature.

The electrolyte uptake in the rubber separators (5 samples in total) with swelling was determined by measuring the weight increase and calculated according to equation below.

$$Uptake ( \% ) = \frac{{W}_{t} - {W}_{0}}{{W}_{0}} \times 100 \%$$

where W₀ is the weight of the dry separator before swelling, and Wₜ is the weight of the separators swelling for a certain time t. Before measuring Wₜ, the swelled separators were wiped by filter paper to remove extra liquid electrolyte on the surfaces.

A Zeiss Merlin HRSEM scanning electron microscope was used to examine the morphology of rubber separators before and after swelling.

Tensile strength and elasticity tests were carried out using Q800 Dynamic Mechanical Analyzer (TA instrument). The rubber and PP separator samples used are strips with width of about 1.5 mm and length of about 2 cm, and the force loading and unloading rate was 0.5 N/min.

Discharge charge cycles of the capillary cells were conducted using the Reference 3000 instrument. While cycling, the electrodes section was video recorded by an optical micro zoom inspection system (Scienscope. MZ7A).

### Example 2: Results

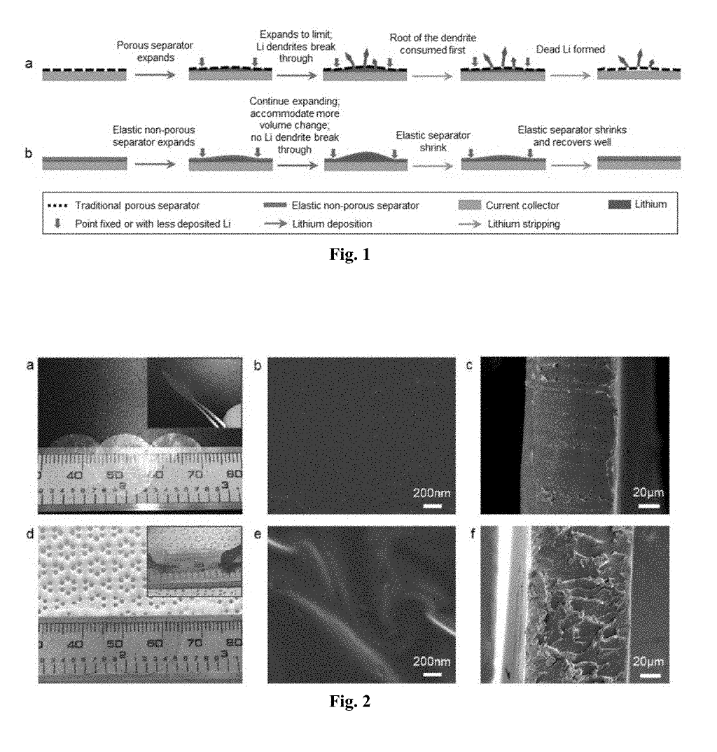

Investigation was directed to whether an elastic, fully dense (non-porous) solid-electrolyte separator combined with liquid organic electrolyte could assist in improving contact quality with self-stress that can help store and eject content reversibly, similar to a blown-up balloon. FIG. 1b shows a schematic design of this concept. Compared to traditional porous organic separators, where the ability to accommodate uneven volume change by elastic deformation is limited, and the pores allow diffusion, limited dendrite growth, and penetration, a fully-dense elastomeric solid-electrolyte separator has no risk of being penetrated through pores. Wu et al., Improving battery safety by early detection of internal shorting with a bifunctional separator, Nat Commun 5 (2014), which is hereby incorporated by reference. When a separator can deform elastically, it automatically exerts a compressive stress against lithium anode when resisting local volume expansion. A widely accepted guideline in the battery literature is that the Young's modulus of a Li-ion conducting electrode separator must exceed 6.8 GPa in order to block dendrite penetration. Monroe & Newman, The impact of elastic deformation on deposition kinetics at lithium/polymer interfaces, J Electrochem Soc 152, A396-A404 (2005), which is hereby incorporated by reference in its entirety. In contrast, in the present disclosure, it was surprisingly discovered that even if the solid-electrolyte separator is softer by a substantial factor, such as, for example a factor of 10⁴, dendrite penetration is still be prevented if the separator can have a large elastic deformation strain range. The non-porous separator described herein, after swelling in an organic liquid electrolyte solution, was observed to have about a 3× higher ionic conductivity than liquid-electrolyte-soaked microporous polypropylene (PP) separator (Celgard 2400). The non-porous separator described herein further performs exceedingly well in coin cells at a high current density of 10 mA cm² and capacity of 10 mAh cm². These results are surprising and suggest that an elastomeric solid electrolyte separator, as described herein, can vastly improve the performance of a lithium metal anode beyond that of anything in the art.

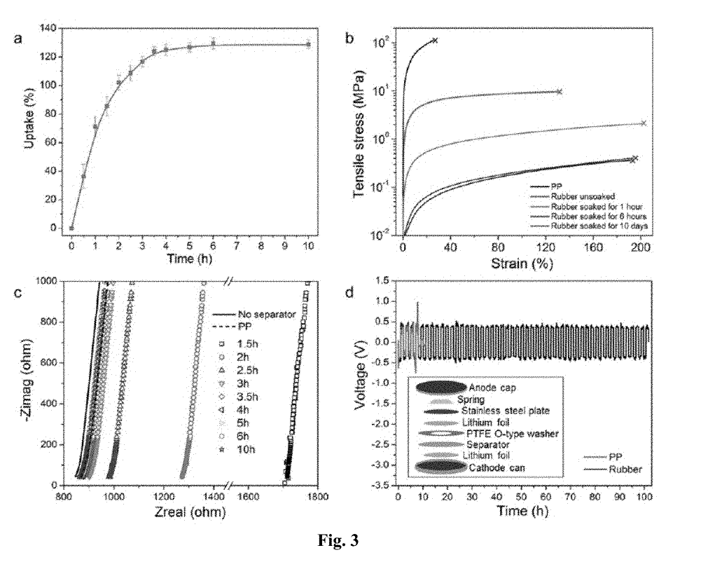

As shown in FIGS. 2a, 2b and 2c, before the immersion in the organic liquid electrolyte, the diameter and thickness of the rubber separator was about 16 mm and about 90 μm, respectively. The separator had no visible pores at 1 nm, which was the highest magnification of the scanning electron microscope (SEM). For comparison, there are extensive pores having a mean diameter of about 30 nm in traditional PP separator (FIG. 6). After a 30 day immersion in organic liquid electrolyte, the diameter increased to about 19 mm, and the thickness increased to about 100 μm (FIGS. 2d and f). There were still no pores in the separator and no obvious dissolution of the material seen at 1 nm (FIG. 2e), although liquid imbibition occurred at the molecular scale, similar to hydrated Nafion. These results indicate that this particular rubber can accommodate limited swelling in the liquid bath to form a single-phase solid electrolyte alloy with the carbonate solvent and LiPF₆, salt. As shown in FIG. 3a, during immersion, the weight gain of the rubber separator increased with soaking time in the first 4 hours and then leveled off at about 125 wt %. FIG. 3b shows that the tensile strength of the rubber, about 10 MPa, is an order of magnitude lower than that of the PP separator (about 110 MPa) and further decreases to about 0.4 MPa after being saturated with organic liquid electrolyte. However, the tensile failure strain of the swelled rubber (about 200%) is much higher than PP. The swelled rubber exhibits good elasticity. A fully reversible recovery was observed after a deformation up to strain of 100%.

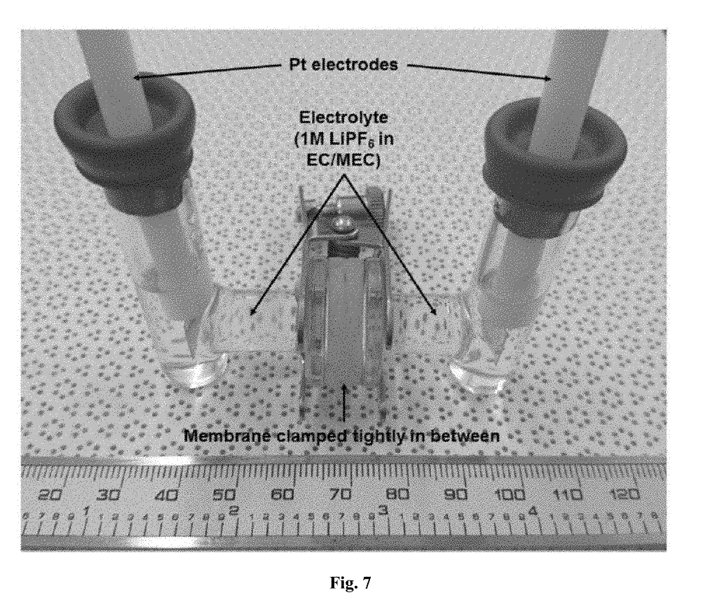

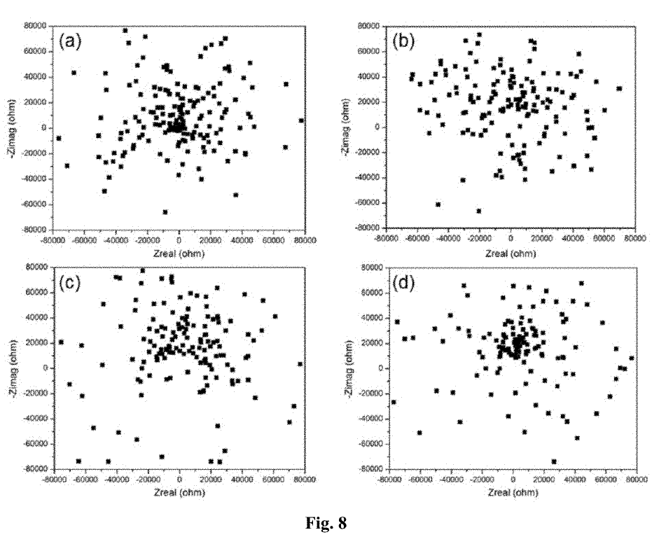

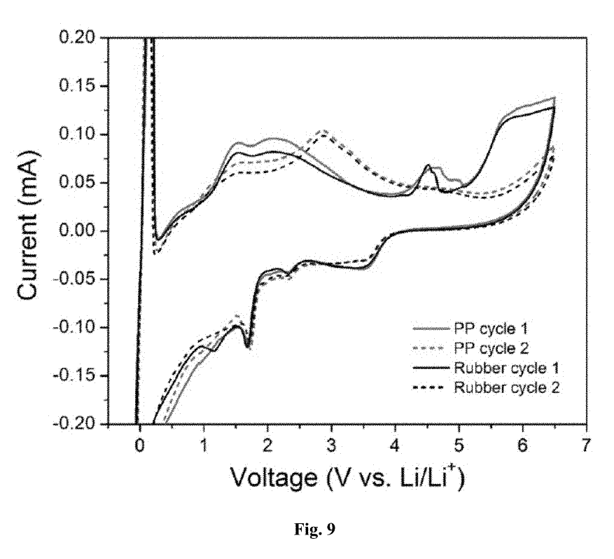

To characterize the Li-ion conductivity of the fully dense rubber separator described herein, an organic liquid electrolyte filled H type cell with two Pt electrodes and a rubber separator in between was assembled (FIG. 7). For comparison, H type cells employing no separator, the porous PP separator, and dense polyvinylidene difluoride (PVDF) separator without any ionic conductivity were also assembled. AC impedance spectra for the H-type cells are shown in FIG. 3c. In the first 1 hour after assembly, the impedance spectrum of the rubber separator consisted of random spots, as observed in the control case of a dense non-conductive PVDF separator (FIG. 8), indicating that the lithium ion conductive pathways had not yet been established. However, after immersion for 1.5 hours, with liquid electrolyte uptake into the solid rubber exceeding 80 wt %, the impedance spectrum assumed the shape of diagonal line, roughly parallel to the spectra of the cells using no separator and PP separator, but shifted to much higher resistance (real part of impedance). With increased soaking time, this additional resistance dropped in proportion to the liquid uptake and reached the same low level of PP separator based H cell, slightly shifted from the impedance arc of the separator free cell. These results confirmed the rubber separator's excellent capability to conduct lithium ions after adequate alloying with the organic liquid electrolyte. Since the liquid-soaked micro-porous PP separator is thinner (about 30 μm) than the rubber separator of the present disclosure (about 100 μm), the final effective Li-ion conductivity is actually about 3× better. Cyclic Voltammetry tests prove that the rubber separator as described herein also has a good electrochemical stability window (FIG. 9).

To compare the ability of the separators to withstand non-uniform lithium growth and electrode volume change, symmetrical Li—Li coin cells were assembled using the swelled rubber separator of the present disclosure, as well as a porous PP separator control, and cycled at a high current density of 10 mA cm⁻² with a high discharge-charge capacity of 10 mAh cm⁻². In each symmetrical cell, a 50 μm thick PTFE washer was sandwiched between the anodic lithium metal and the separator to reserve space for electrode volume change and allow for uneven deposition of lithium beneath the separator. As shown in FIG. 3d, for the cell with porous PP separator, after only 4 cycles, the voltage dropped dramatically because of internal short due to lithium dendrite penetration. In contrast, the cell with the fully dense rubber separator of the present disclosure was cycled for 50 cycles, and no internal short was observed. Surprisingly, although the mechanical strength and Young's modulus of the soft, swelled rubber separator are very low, it can still prevent the lithium dendrite penetration and survive electrode volume change at a high current density of 10 mA cm⁻² and a high capacity of 10 mAh cm².

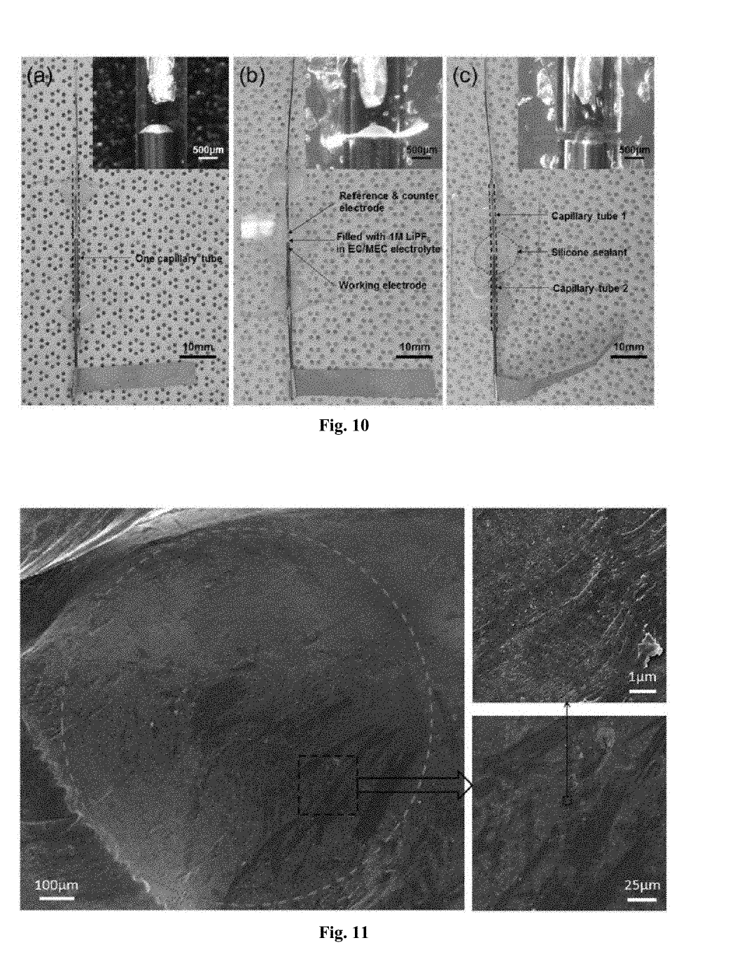

In order to better understand the excellent performance of the rubber separator described herein compared to the PP separator, three transparent glass capillary cells, containing either a PP or rubber membrane or no membrane, were fabricated to study the interaction between the separator and electrode in situ. The structure of the capillary cells is shown in FIG. 10. Six discharge charge cycles of the capillary cells at a constant current density of 10 mA cm⁻² (with respect to the area of copper wire electrode) were conducted, and the dynamics of electrode interface were recorded simultaneously. In each cycle, first discharge for a certain period of time to deposit lithium onto the bare cross section of the copper wire, and then charge to strip the lithium the voltage rises to >5 V.

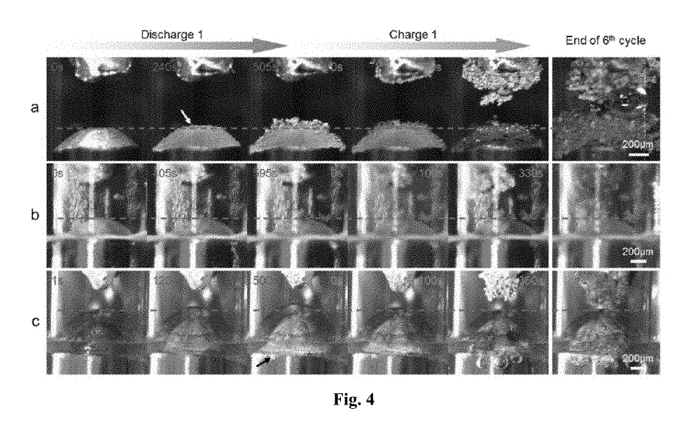

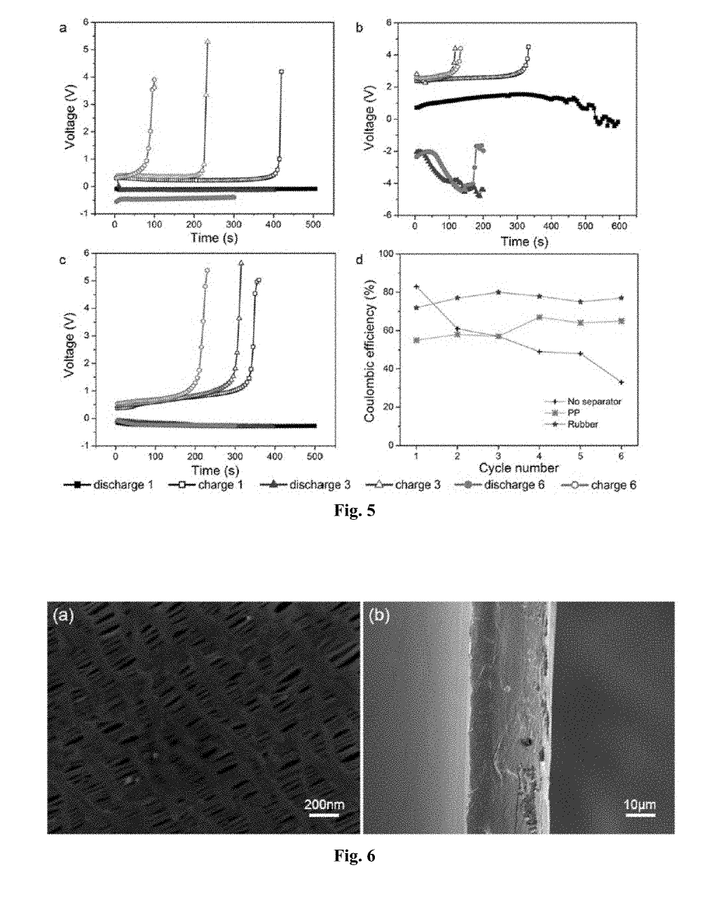

FIG. 4a shows the cycling behavior of the capillary cell without any separator. In the first 240 seconds of discharge, lithium metal deposited relatively uniformly on the copper wire electrode, while from the 240^{th} second on, as indicated by the white arrow, clusters of lithium deposits began to grow, and resulted in a layer of highly mossy lithium on the top at the end of discharge. In the following charge process, the deposited lithium shrunk while its color darkened, indicating the reaction between lithium metal and organic liquid electrolyte. At the 420^{th} second of charge, a layer of dark grey product remained which could not be stripped. Meanwhile, the charge voltage rose sharply (FIG. 5a), and small bubbles were generated, which merged and grew bigger in the following cycles. However, the generating of bubbles was observed only at the end of first charge, although the voltage rose high as well in the following charge cycles. Without being bound by any particular theory, this might be due to passivation and SEI formation on the surface of copper wire electrode. As shown in FIG. 5a, the charge-discharge voltage gap increased with the cycle number, which indicated the increase of internal resistance. After six cycles, a thick layer of dark grey product, which could not be cycled anymore, accumulated on the working electrode. Without intending to be bound by any particular theory, the growth of this product is the likely cause of the dramatically decreased Coulombic efficiency, shown in FIG. 6d. It is believed that without any mechanical restriction, lithium metal electrodes grow non-uniformly to form mossy structures and dendrites with a large specific surface area very quickly upon cycling, which accelerates side reactions between lithium metal and organic liquid electrolyte and leads to poor Coulombic efficiency.

FIG. 4b reveals the interaction between the porous PP separator and the lithium metal electrode. During discharge, lithium metal is deposited onto the copper wire electrode under the PP separator. However, at about the 405^{th} second, a lithium dendrite penetrated through the PP separator and continued growing, as indicated by the upper red arrow. Meanwhile, as labeled by the lower arrow, some lithium grew backward through the gap between the enameled copper wire and PP separator due to incomplete encapsulation. At the end of first discharge, there were several lithium dendrites deposited above the separator which could not be stripped while charging and eventually became “dead lithium”. Throughout the entirety of the test, the PP separator barely deformed, indicating that there was little mechanical stress exerted by growing lithium whiskers and dendrites on PP separator. The PP separator was removed and cleaned in ethanol after the cycling test and observed using SEM. No breakage was observed, and the porous structure of the separator was well maintained (FIG. 11). Therefore, it is reasonable to infer that it was along the original pores of the PP separator that the lithium dendrites grew and finally penetrate the separator. It can be imagined that when confined within the pores of the separator, the lithium dendrites should be very thin, sparse and fragile, possibly growing along in thin films along the internal surfaces at high rates, as observed for copper electrodeposition in nanoporous media. Han et al., Overlimiting current and control of dendritic growth by surface conduction to nanopores. Scientific Reports 4, 7056 (2014); Han et al., Dendrite suppression by shock electrodeposition in charged porous media, Scientific Reports 6, 28054 (2016), both of which are hereby incorporated by reference. During charging, the thin parts of the dendrites inside the separator were quickly consumed first; therefore, the outer part of the dendrite lose electrical contact with the electrode and become “dead lithium”.

Another capillary cell was assembled using the same PP separator, and cycled at a current density of 100 mA cm², where the process of dendrite penetration leading to “dead lithium” was clearly observed. FIG. 5b shows typical discharge-charge curves of the cycles. In the first discharge, the discharge voltage suffer a fluctuation after lithium dendrite breaking through the separator. In the subsequent cycles, the charge-discharge voltage gap became much larger, indicating a huge increase in internal resistance. Referring to the behavior of the cell without a separator, this phenomenon could be attributed to the blockage between the electrode and the separator caused by a sheet of gas bubbles (akin to the Leidenfrost effect), which were generated at the end of first charge when the local voltage got too low (relative voltage too high). After the sixth charge, there were some lithium dendrites and a layer of grey reaction product observable above and beneath the PP separator, respectively. However, the total amount of lithium, per volume or per area, was much less than that in the cell without a separator. The Coulombic efficiency of the cell kept stable at about 60% and did not drop with increasing cycle numbers (FIG. 5d). Without intending to be bound by any particular theory, this phenomenon might be attributed to a small increase in surface area of lithium metal for SEI formation on working electrode, constrained by the PP separator. Nevertheless, the formation of the “dead lithium” still contributes to the loss of active material in each cycle.

FIG. 4c shows the behavior of the lithium metal electrode cohered by our elastomeric separator. It is very clear that the separator expanded as lithium metal deposited onto the copper wire electrode beneath it, and under restriction by the separator, the deposited lithium had a relatively flat morphology without any large size lithium protrusions that could begin to puncture the separator. Because of the non-porous structure of the rubber separator, there was no easy access for lithium dendrite to grow through. As in the PP based cell, some lithium grew backward due to incomplete encapsulation, as indicated by the black arrow. While charging, with stripping of lithium metal, the expanded elastomeric separator shrunk back gradually to its original position. Similar to a balloon, the rubber separator can expand and shrink repeatedly following the volume change of the lithium metal electrode. At the end of first charge, the generation of gas bubbles were observed, but interestingly, instead of gathering into a sheet (as in Leidenfrost effect that gives rise to boiling crisis) and being trapped between the electrode and separator, most, if not all of the gas bubbles were expelled under the excess pressure created by the rubber separator. As a result, gas bubbles did not affect the quality of electrical contact in the following cycles. After six cycles, there was also a layer of grey matter left on the copper wire electrode, but confined by the elastomeric separator, the layer was not mossy and without any obvious increase in the whole volume of the electrode.

FIG. 5c illustrates that discharge-charge curves of the capillary cell employing the rubber separator as described herein were very stable. There was almost no change in the charge-discharge voltage gap, which indicated a stable internal resistance and a good moving electrode-electrolyte contact, in spite of the existence of side reactions and bubbles. Consequently, the Coulombic efficiency of the rubber separator-based cell was the best among all the three kinds of capillary cells (FIG. 5d). All of these results confirm that the rubber separator enhanced the cycling performance and rate capability of the lithium metal anode.

Comparing the three capillary cells, it can be concluded that different separators create different kinds of physical confinements on the deposition and stripping of lithium metal, resulting in different behavior and performance of the lithium metal anode. In the first case of no confinement, mossy lithium and dendrites can grow freely, leading, to highly non-uniform lithium deposits in just a few cycles. The number of side reactions increases in each cycle due to the increasing surface area of the lithium metal, leading to a dramatically decreasing Coulombic efficiency. In the second case of “rigid confinement”, a PP separator with a high tensile strength but poor range of elasticity confines the deposited lithium metal to the limited space between it and the electrode, which can make the lithium less mossy and control the amount of the side reactions in each cycle. As a result, the Coulombic efficiency becomes more stable. However, the confinement is so strict that lithium has no space to grow once the space is filled up, and in this case, the lithium is forced to grow inside the pores of the PP separator, eventually leading to penetrating dendrites and dead lithium upon current reversal, with low Coulombic efficiency. In the third case of “soft confinement” by the novel elastomeric separator described herein, the morphology of the lithium electrode during cycling is tightly controlled by exerting a compressive stress on it, while at the same time accommodating the large volume change of the lithium metal electrode through elastic deformation of the rubber separator. The compressive stress is large enough to expel gas bubbles and maintain spontaneous interface tracking without delamination. Good contacts are preserved between the lithium metal (including lithium particles dropped off from the bulk lithium metal) and the electrode, thereby reducing the formation of “dead lithium”. On the other hand, the elastic deformation range is large enough to avoid a fierce “poke block” confrontation between dendritic lithium and the non-porous rubber separator, that significantly decreases the possibility of the rubber separator's being punctured, despite its very low mechanical strength and Young's modulus. The stable discharge-charge curves and relatively high Coulombic efficiency of the capillary cell establish the effectiveness of such a mechanically soft, solid barrier. The results of the visual capillary cell experiments confirm the hypothesis illustrated in FIG. 1 and provide clarification for the coin cell test results shown in FIG. 3d.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A non-porous battery separator comprising an elastomeric material, wherein the elastomeric material is permeable to metal ions but not appreciably permeable to other chemical species.

2. The non-porous battery separator of claim 31, wherein the elastomeric material is either partially or fully immersed in an electrolyte solution.

3. The non-porous battery separator of claim 2, wherein the electrolyte solution is an organic liquid electrolyte solution.

4. The non-porous battery separator of claim of claim 3, wherein the organic liquid electrolyte solution is 1 M LiPF₆ in EC/MEC (3:7 v/v).

5. The non-porous battery separator of claim 1, wherein the thickness of the separator is from about 1 μm to about 200 μm.

6. The non-porous battery separator of claim 1, wherein the diameter of the separator is from about 3 mm to about 50 mm.

7. The non-porous separator of claim 1, having a tensile strength from about 50 Pa to about 50 MPa.

8. The non-porous battery separator of claim 1, wherein the separator has an electrical resistance from about 100 Ohms to about 5000 Ohms.

9. The non-porous battery separator of claim 1, wherein there are no visible pores in the elastomeric material at a resolution of 1 nm.

10. The non-porous battery separator of claim 1, wherein the non-porous battery separator is impermeable to lithium dendrites.

11. The non-porous battery separator of claim 1, wherein the permeable metal ions are Li⁺.

12. A battery comprising the non-porous battery separator of claim 1.

13. The battery of claim 12, wherein the battery is a Li-ion battery.

14. The battery of claim 12, wherein the Coulombic efficiency is greater than about 50% after the 120th charge cycle.

15. The battery of claim 12, wherein the Coulombic efficiency is greater than about 75% after the 70th charge cycle.

16. The battery of claim 12, wherein the Coulombic efficiency is from about 75% to about 80% after the 6^{th} charge cycle.

17. The battery of claim 12, wherein there is no observed drop in voltage after 50 cycles.

18. The battery of claim 12, wherein the current density of the cell is 10 mA cm⁻² and the areal capacity is 10 mAh cm².

19. The battery of claim 18, further comprising a PTFE washer between the anode and the separator.

20. The non-porous battery separator of claim 1, wherein the elastomeric material applies a compressive stress when the non-porous battery separator is mechanically coupled to a lithium electrode.

21. The non-porous battery separator of claim 1, wherein the elastomeric material is deformable with a strain up to 100%.
